(19) United States
(12) Patent Application Publication
(10) Pub. No.: US 2024/0233504 A1
(43) Pub. Date: Jul. 11, 2024

(54) VISIBILITY IMPAIRING DEVICE

(71) Applicant: Essence Security International (E.S.I.) Ltd., Herzlia Pituach (IL)

(72) Inventors: Pavel LINDBERG, Rosh HaAyin (IL); Jacob GABAY, Rosh HaAyin (IL); Eran COHEN, Tel-Aviv (IL); Eran VENDRIGER, Tel-Aviv (IL); Sergey MERON, Netanya (IL)

(21) Appl. No.: 18/563,837

(22) PCT Filed: May 24, 2022
(86) PCT No.: PCT/IL2022/050543

§ 371 Date: Nov. 22, 2023

(30) Foreign Application Priority Data
May 25, 2021 (IL) 283435

(51) Int. Cl. G08B 15/02

(52) U.S. Cl. CPC G08B 15/02

(57) ABSTRACT

Disclosed herein is a visibility-impairing device, such as a visibility-impairing security device, for providing air-suspended light-obscuring matter. The device comprises a body for holding an emission unit, wherein the emission unit has an outlet for emitting the matter. The body comprises a first opening for the passing therethrough of the matter from the outlet; and at least one second opening configured for the passage of the matter therethrough, at least in an event that that first opening is closed.

### RELATED APPLICATION

This application claims the benefit of priority of Israel Patent Application No. 283435 filed on 25 May 2021, the contents of which are incorporated herein by reference in their entirety.

### TECHNICAL FIELD

The present disclosure relates to a visibility impairing systems and components thereof. Particularly, but not exclusively, the present disclosure relates to visibility impairing security devices.

### BACKGROUND

Visibility-impairing security devices can be used to provide an emission that results in a gathering of air-suspended light-obscuring matter, such as a composition of water vapour or smoke, in order to make it difficult for an intruder to see their environment.

The emission of such matter from the device may be prevented if the outlet of the device for emitting the matter is blocked. The present inventors have recognized that such blockages may lead to damage to the device and/or other undesirable consequences.

### SUMMARY

At least one aspect is defined by the independent claims. Preferred features are described by the dependent claims.

A first aspect of the present disclosure provides a visibility-impairing device, such as a visibility-impairing security device, for providing air-suspended light-obscuring matter, the device comprising:
a body for holding an emission unit, wherein the emission unit has an outlet for emitting the matter, the body comprising:
   a first opening for the passing therethrough of the matter from the outlet; and
   at least one second opening configured for the passage of the matter therethrough, at least in an event that that first opening is closed.

The first and second openings may be external openings of the body, e.g. allowing the passage of the matter therethrough so as to provide the matter to a region external to the body.

The provision of the air-suspended light-obscuring matter by the device may be so as to obscure vision, e.g. in the vicinity of the device or at least in the region external to the body. The air-suspended light-obscuring matter may be or comprise at least one of particulate matter, smoke, cloud, vapour, and/or the like.

The body may be elongate.

The body may comprise or be configured to receive a mounting member. The mounting member may be arranged for mounting the body to a surface, such as a wall, ceiling, post, or other surface capable of supporting the device. The mounting member may comprise a mounting bracket. The body may comprise a main body portion. The main body portion may be shaped or otherwise configured to hold the emission unit therein. The main portion may at least partially define a chamber for holding the emission unit therein. The chamber may comprise an access opening for allowing passage of the emission unit into and out of the chamber. The access opening may be in at least one end of the chamber, such as a bottom end when the mounting member is mounted against a vertical wall. The access opening may be releasably closable by a closing member, such as a lock ring or other closing member, to secure the emission unit in the chamber. The chamber or the closing member may comprise an emission aperture therein to allow passage of the light-obscuring matter therethrough. The chamber may be configured such that the emission aperture is aligned with the outlet of the emission unit when the emission unit is installed in the chamber so that an emission trajectory from the outlet passes directly though the emission aperture. The main body portion may contain substantially the entire emission unit or at least an entire longitudinal length of the emission unit. The emission unit may preferably be fully enclosed within the body, e.g. within the main body portion.

The mounting member may be connected or connectable to a main body portion, and may optionally be releasably connected or releasably connectable to a main body portion, e.g. to allow the main body portion to be selectively attached and removed from the mounting member. The mounting member may, for example, be connectable to the body portion by a releasable mating. For example, the main body may be slidable onto the mounting member and into a connecting engagement (e.g. a reversable snap fit or other reversible connecting engagement) therewith. In this example, one of the mounting member or the main body portion may define slide guides or rails and the other of the mounting member or the main body portion may define corresponding followers to guide and follow the slide guides or rails so as to slidably guide the main body or mounting portion into the connecting engagement. One of the mounting member or the main body portion may comprise releasable snap-fit engagement members and the other of the mounting member or the main body portion may comprise a corresponding recess or engagement portion for receiving the releasable snap-fit engagement members in a reversible snap-fit connection.

This arrangement may allow the mounting member to remain fixed to the surface, whilst the main body portion may be selectively removed, e.g. to replace the emission unit or batteries, and selectively re-connected to the mounting member.

At least one of: the main body portion and/or the mounting member may be formed from a polymeric material, or predominantly formed from a polymeric material.

The first opening may be located proximal to, at or towards a first end of the body. The device may be configured such that, when the device is mounted or in use, the first opening may be on a bottom end, lower half or lowermost part of the body, e.g. the first end may be or comprise the bottom end of the body when the device is mounted or in use. The body may be configured to hold the emission unit such that, when the emission unit is held in the body, the outlet of the emission unit is at an end, such as a bottom end, of the emission unit. The first opening may be configured to emit the light-obscuring matter downwardly or obliquely downwardly, such as obliquely downwardly and forwardly.

The second opening may be on a different side, end, face or surface of the body to the first opening. The second opening may be proximal a second end of the body that is opposite the first end. The second opening may be on an opposite side, end, face or surface of the body to the first opening. The device may be configured such that, when the device is mounted or in use, the second opening may be in or proximal to a top end of the device, or in the upper half or uppermost most part of the device. The second opening may be configured to emit the light-obscuring matter at least partially from the rear of the device. The second opening may be configured to emit the light-obscuring matter in a different direction to the first opening, e.g. the second opening may be configured to emit the light-obscuring matter at least partially or entirely rearwardly from the device, e.g. directly rearwardly or obliquely rearwardly from the device.

The body may define or otherwise comprise a first cavity arranged or extending between the first opening and one or both of: the emission aperture in the chamber or closing member and/or the outlet of the emission unit. The first cavity may be configured to provide fluid communication between the outlet of the emission unit, when the emission unit is installed in the device, and the first opening of the body. The first cavity may be configured to allow the light-obscuring matter to pass through the first cavity from the outlet to the first opening, e.g. to thereby be expelled from the device into the region external to the body.

The body may define or otherwise comprise at least one second cavity. The at least one second cavity may be arranged in a fluid communication path between the outlet and the second opening, when the emission unit is installed in the body. The at least one second cavity may be arranged in the fluid communication path between one or both of: the first chamber and/or the emission aperture in the chamber or closing member and the second opening, when the emission unit is installed in the body.

The at least one second cavity may be provided at and/or adjacent the second opening. At least part or all of the at least one second cavity may be provided at the second end of the body. At least part or all of the at least one second cavity may be provided above the chamber and/or the emission unit, e.g. when the body is mounted or in use. The at least one second cavity may be fluidically connected with the second opening. At least part or all of the at least one second cavity may be arranged towards the second side of the body with respect to the chamber for holding the emission unit.

The at least one second cavity may be configured to provide fluid communication between the outlet of the emission unit, when the emission unit is installed in the device, and the second opening of the body. The at least one second cavity may be configured to allow the light-obscuring matter to pass through the at least one second cavity to the second opening, e.g. to thereby be expelled from the device into the region external to the body. The fluid communication path between the outlet and/or emission aperture and the second opening may comprise the first cavity. That is, the at least one second cavity may be in the fluid communication path with the first cavity for fluid communication therewith.

At least one or each of: the first opening, the first cavity, the fluid communication path, the at least one second cavity and/or the second opening may be configured such that, when the first opening is open and/or unobstructed, then there is preferential flow or passage of the light-obscuring material to the first opening relative to the flow or passage of the light-obscuring material to the second opening. By way of example, the at least one second cavity or another part of the fluid communication path may have a total cross sectional area that is less than a cross sectional area of the first cavity. As another example the second opening may have an opening area that is less than an opening area of the first opening. As another example, the at least one second cavity or another part of the fluid communication path between the first cavity and the second outlet may define a more tortuous fluid communication path than the first cavity. As another example, the at least one second cavity or another part of the fluid communication path between the first cavity and the second outlet may comprise a flow restriction, choke point, throttle, throttle valve, biased flap valve, or other valve or construction for restricting and/or selectively permitting and blocking flow, at least relative to the first cavity or first aperture.

The second opening may be permanently open, e.g. permanently uncovered.

The at least one second cavity may be configured to vent heat generated by the emission unit. The body may be configured to hold the emission unit such that heat from the emission unit is passed into the at least one second cavity. The second cavity and/or the second opening may configured as both a heat dissipation mechanism for dissipating heat from the emission unit and a route for emitting the light-obscuring matter. As such, the second cavity and/or the second opening may have a dual function, which may simplify construction and/or improve operation of the device.

The body may comprise one or more heat transfer portions that extend from the chamber to the second cavity. The one or more heat transfer portions may be open channels or voids or may be channels filled with heat conducting material, such as a metallic, ceramic, carbon or other heat conducting material. Parts of the body surrounding the heat transfer portions may be formed from thermally insulating material, such as polymeric material. The heat conducting material may have a thermal conductivity of at least twice, at least five time or an order of magnitude more than that of the thermally insulating material. In this way, the at least one second cavity may improve dissipation of heat generated by the production of the light-obscuring matter. The above arrangement may provide a more controlled dissipation of heat in a way that may help protect other components of the device.

The emission unit may generate the light-obscuring matter upon delivery of energy. The emission unit may comprise a canister in which the smoke is generated. The emission unit (e.g. the canister) may contain chemicals that react to generate the light obscuring matter, which may involve an exothermic reaction.

The canister may be formed from, or may comprise, a metallic or other heat conducting material, e.g. the canister may be a metallic canister or at least an inner layer of the canister may be formed from the metallic or other heat conducting material. The canister or at least the inner layer of the canister may be configured to conduct heat released during formation of the light-obscuring matter. The chemicals that react to generate the light obscuring matter may be contained or comprised within the canister.

The emission unit may optionally further comprise a housing, which may be for holding the canister. The housing may be a thermally insulating housing. The housing of the emission unit may optionally be formed from a polymeric or other heat insulating material. The housing may be a container for containing the canister. The housing may be or comprise a layer of polymeric or other heat insulating material disposed on the outer surface of the canister. The housing may cover at least some or all of an outer surface of the canister.

The canister and optionally the housing may each comprise a cylindrical side wall. The canister and optionally the housing may have a first end (e.g. a bottom end) and second end (e.g. a top end) opposite the first end. The first end of the canister and optionally the housing may comprise the outlet of the emission unit. The second end of the housing may comprise one or more heat conduction arrangements, which may be configured to facilitate transfer of heat from the canister into the second cavity. The one or more heat conduction arrangements may be left open or at least partially filled with the metallic or other heat conducting material. The heat conduction arrangements may be provided at the second end of the housing, and may extend at least partway or entirely through the housing. The heat conduction arrangements may comprise slots. The heat conduction arrangements may be configured to align, be adjacent or proximate to, or be in register with the heat transfer portions into the second cavity, which may facilitate better transfer of heat out from the emission unit to the second cavity, and thereby out of the device via the at least one second opening.

The mechanisms described above contribute to heat control of the device, wherein heat generated by the generation of the light-obscuring matter may be suitably channeled and/or dissipated from the container. The heat may also be prevented from impacting heat sensitive components. The heat conduction through channels may be provided at or towards an end, such as a top end, of the canister or in the top half of the canister. As heat rises, the location of the heat transfer portions, heat conduction arrangements and/or the second cavity at the second or upper end may better facilitate conduction of heat from the canister.

The at least one second cavity may be comprised of sub-cavities divided from each other. The sub-cavities may be distributed laterally in the device. The sub-cavities may be elongate. The sub-cavities may extend generally longitudinally in a long direction of the device. At least two of the sub-cavities may, for example, be divided by an electronics module containing a circuit for controlling, operating and delivering energy to the emission unit. The circuit may be housed in an insulating electronics housing so as to be protecting from heat that accrues in the second cavity during emission of matter from the emission unit. The circuit may comprise terminals for receiving wires, e.g. for one or more of: providing control signals for controlling the circuit; for providing control signals; and/or providing the energy to the emission device.

The body may comprise an exterior rear wall. The second opening may pass through the exterior rear wall.

The device may further comprise a lens component, which may be a lens of a motion and/or presence detector or camera. The motion and/or presence detector may be configured to detect motion and/or presence of a living entity.

Rear may be defined as being an opposing side to the lens component. The exterior rear wall may be an exterior wall of the body that is on the opposite side of body to the lens component. An exterior wall of the body comprising the lens component may be a front wall, the exterior wall of the body opposite the front wall and comprising the second opening may be a rear wall. The first and second ends (e.g. the top and bottom ends) of the body may extend generally perpendicularly to the front and rear walls. The lens component may provide a sensor (e.g. a pyroelectric sensor of a PIR motion detector or an image sensor) with a field of view that is symmetric about a longitudinal axis of the body passing through the first and second ends (e.g. through the top and bottom ends), preferably in a perpendicular manner. The field of view may span more towards the bottom end of the body than the top end of the body so as be directed more towards a floor than a ceiling when installed in a room.

The mounting member may comprise the exterior rear wall. The exterior rear wall may be generally curved about the longitudinal axis of the body. The exterior rear wall of the mounting member may comprise one or more mounting structures for mounting to the surface. The mounting structures may comprise, for example, a screw locator that may comprise a thinned portion of exterior rear wall for tapping a screw therethrough, one or more adhesive members such as elongate adhesive pads, one or more screw holes, and/or the like.

The exterior rear wall may comprise at least one mounting face. At least two of the mounting faces may be oriented at different angles. The mounting faces may be substantially flat faces. The mounting faces may protrude outwardly or otherwise stand proud from the rest of an outer surface of the exterior rear wall. The exterior rear wall may be predominantly curved, e.g. curved apart from the at least one mounting face. One or more or each of the mounting faces may be provided with one or more mounting structures. In an example, the exterior rear wall comprises a plurality of mounting faces that include a central flat mounting face between lateral flat mounting faces. The lateral mounting faces may each be at 45 degree angles to the central flat mounting face. The mounting faces may be configured to lie in a vertical plane when mounted, and may each have a longitudinal axis that is vertical. In another example, one of the lateral mounting faces may be provided at a different angle with respect to the central mounting face relative to the other of the lateral faces. For example, one of the lateral faces may be provided at substantially 450 to the central face and the other of the lateral faces may be provided at substantially 900 to the central face.

The main body portion may comprise an interior rear side, e.g. an interior wall. The interior rear side may be rearward of, or form a rearward part of, the chamber of the body for holding the emission unit. The interior wall may define part, such as a rear part, of the chamber for holding the emission unit. The interior rear side may be provided between the emission unit in use, or the chamber of the body in which the emission unit is held, and the exterior rear wall. The exterior rear wall and the interior rear side may define, or be provided on, opposing sides of at least part of the fluid communication path, e.g. a part of the fluid communication path including the second cavity or between the first cavity and the second opening. The interior rear side may be part of the main body portion. The rear side may advantageously be rigid to provide additional structural integrity and strength to an emission unit housing portion of the body. The interior rear side may be curved about the longitudinal axis of the body of the device. This arrangement with a “double wall”, i.e. the interior rear side and the exterior rear wall with part of the fluid communication path therebetween, may provide additional structural support and rigidity to the body.

The outlet of the emission unit may be oriented to direct the matter downwards and forwardly, but optionally more downwards than forwardly, when the matter is emitted.

The device preferably further comprises a cover (e.g. a door hinged to a bottom portion of the body of the device) for selectively closing the first opening. The cover may be configured to be operable between a closed configuration in which the cover closes the first opening and an open configuration in which the first opening is at least partially, mostly or fully uncovered. The cover may be configured to be operable into the open configuration when the light-obscuring matter passes or is to pass through the first opening. The cover may be operable into the open configuration by the release of the light-obscuring matter from the outlet of the emission unit, e.g. due to force or pressure exerted by the light-obscuring matter.

The bottom portion of the body of the device may be releasably attachable to the main body portion of the device, optionally after the main body portion of the device is attached to the mounting member. The bottom portion may extend beyond the main body portion, e.g. beyond the rear side of the main body portion, to close against the mounting member. By this or any other means, the part of the fluid communication path between the first cavity and the second opening may include a path portion at least partly defined by the bottom portion, e.g. to extend below the interior rear side of the main body portion before the fluid communication path extends up between the interior rear side and the exterior rear wall.

Preferably the first opening and the outlet and/or emission aperture are configured so that emission of the matter from the outlet is directed directly through the first opening, e.g. the outlet is oriented towards the first opening.

The location of the second opening being at the top (and preferably rear) of the device may make the second opening difficult to see and/or reach from below, which may help prevent deliberate blocking. The provision of a second opening may provide a further or secondary opening to allow emission of the light-obscuring matter from the device, even if the first opening is partially or fully occluded, for example, by the cover being jammed or otherwise held shut. Furthermore, the second opening (and second cavity) may serve a dual purpose both as a further or secondary opening to allow emission of the light-obscuring matter from the device and also as a heat dissipation conduit. Furthermore, the arrangement of the interior rear wall and the exterior rear wall may provide additional structural rigidity.

In examples, the body may be configured to removably hold the emission unit, e.g. so that the emission unit can be selectively inserted into the body and selectively removed, e.g. to allow replacement of the emission unit. In examples, the device may comprise the emission unit. In examples, the emission unit may be separate or separable from the device.

A second aspect of the present disclosure provides a kit of parts or assembly comprising:
a visibility-impairing device according to the first aspect; and
an emission unit that has an outlet for emitting the light-obscuring matter.

The emission unit may be comprised or locatable in the body of the visibility-impairing device.

The emission unit may generate the light-obscuring matter upon delivery of energy. The light-obscuring matter may comprise smoke. The emission unit may comprise a canister in which the light-obscuring matter is generated. The emission unit (e.g. the canister) may contain chemicals that react to generate the light obscuring matter, which may involve an exothermic reaction.

The canister may be formed from, or may comprise, a metallic or other heat conducting material, e.g. the canister may be a metallic canister or at least an inner layer of the canister may be formed from the metallic or other heat conducting material. The canister or at least the inner layer of the canister may be configured to conduct heat released during formation of the light-obscuring matter. The chemicals that react to generate the light obscuring matter may be contained or comprised within the canister.

The emission unit may optionally further comprise a housing, which may be for holding the canister. The housing may be a thermally insulating housing. The housing of the emission unit may optionally be formed from a polymeric or other heat insulating material. The housing may be a container for containing the canister. The housing may be or comprise a layer of polymeric or other heat insulating material disposed on the outer surface of the canister. The housing may cover at least some or all of an outer surface of the canister.

The canister and optionally the housing may each comprise a cylindrical side wall. The canister and optionally the housing may have a first end (e.g. a bottom end) and second end (e.g. a top end) opposite the first end. The first end of the canister and optionally the housing may comprise the outlet of the emission unit. The second end of the housing may comprise one or more heat conduction arrangements, which may be configured to facilitate transfer of heat from the canister into the second cavity. The one or more heat conduction arrangements may be left open or at least partially filled with the metallic or other heat conducting material. The heat conduction arrangements may be provided at the second end of the housing, and may extend at least partway or entirely through the housing. The heat conduction arrangements may comprise slots. The heat conduction arrangements may be configured to align, be adjacent or proximate to, or be in register with the heat transfer portions into the second cavity of the device, which may facilitate better transfer of heat out from the emission unit to the second cavity, and thereby out of the device via the at least one second opening.

A third aspect of the present disclosure provides a method of assembling the kit of parts of the second aspect, the method comprising inserting the emission module into the body of the visibility-impairing device and/or fixing the main body portion to the mounting member.

The method may comprise locking the emission module in the body, e.g. by using one of: a lock ring, a twist to engage member, a screw threaded member, a click fit member, and/or the like.

The fixing of the mounting member to the body may comprise sliding the mounting member onto the body. The fixing of the mounting member to the body may comprise sliding the mounting member so that followers on one of the body or mounting member slide along slide guides or rails on one of the other of the body or mounting member. The fixing of the mounting member to the body may comprise engaging a fixing mechanism for fixing or releasably fixing the mounting member to the body. The fixing mechanism may comprise, for example, a reversible snap fit arrangement.

The method may comprise fixing a bottom cap to the body. The bottom cap may comprise the cover (e.g. the hinged door or flap). The bottom cap may fit to the body via a sliding fit. The bottom cap may define part of the fluid communication path. The bottom cap may hold or additionally hold the mounting member onto the body.

A fourth aspect of the present disclosure provides a method of disassembling the kit of parts of the second aspect, the method comprising removing the emission module from the body of the visibility-impairing device and/or releasing the main body portion from the mounting member.

The method may comprise releasing a bottom cap from the body. The bottom cap may comprise the cover (e.g. the hinged door or flap). The bottom cap may fit to the body via a sliding fit. The bottom cap may define part of the fluid communication path. The bottom cap may hold or additionally hold the mounting member onto the body.

The method may comprise removing the mounting member from the body. The removing of the mounting member to the body may comprise sliding the mounting member off the body. The removing of the mounting member to the body may comprise sliding the mounting member so that followers on one of the body or mounting member slide along slide guides or rails on one of the other of the body or mounting member. The removing of the mounting member to the body may comprise releasing a fixing mechanism that releasably fixes the mounting member to the body. The fixing mechanism may comprise, for example, a reversible snap fit arrangement.

The method may comprise unlocking the emission module in the body, e.g. by opening one of: a lock ring, a twist to engage member, a screw threaded member, a click fit member, and/or the like. The method may comprise removing the emission module, e.g. by sliding the emission module out of the body.

A fifth aspect of the present disclosure is a body for the vision-impairing security device of the first aspect, the body configured to hold an emission unit, wherein the emission unit has an outlet for emitting the matter, the body comprising:
a first opening for the passing therethrough of the matter from the outlet; and
a second opening enable the passage of the matter therethrough at least in an event that that first opening is closed.

A sixth aspect of the present disclosure provides a computer program comprising computer executable instructions that, when executed by a processor, cause the processor to control an additive manufacturing apparatus to manufacture the body of the fifth aspect.

A seventh aspect of the present disclosure provides a method of manufacturing a product via additive manufacturing, the method comprising: obtaining an electronic file representing a geometry of a product wherein the product is the body according to the fifth aspect; and controlling an additive manufacturing apparatus to manufacture, over one or more additive manufacturing steps, the product according to the geometry specified in the electronic file.

An eighth aspect of the present disclosure provides an emission unit, the emission unit being configured to generate light-obscuring matter upon delivery of energy, wherein the emission unit comprises:
a canister in which the light-obscuring matter is generated;
a thermally insulating housing covering a majority of an outer surface of the canister;
an outlet for emitting the light-obscuring matter; and
the housing comprises one or more heat conduction arrangements that are left open or through which metallic or other heat conducting material extends, the one or more heat conduction arrangements being located at or proximate an end of the housing of the emission unit that is opposite or furthest from an end on which the opening is located.

The emission unit may be locatable in the body of a visibility-impairing device.

The light-obscuring matter may comprise smoke. The emission unit may comprise a canister in which the light-obscuring matter is generated. The emission unit (e.g. the canister) may contain chemicals that react to generate the light obscuring matter, which may involve an exothermic reaction.

The canister may be formed from, or may comprise, a metallic or other heat conducting material, e.g. the canister may be a metallic canister or at least an inner layer of the canister may be formed from the metallic or other heat conducting material. The canister or at least the inner layer of the canister may be configured to conduct heat released during formation of the light-obscuring matter. The chemicals that react to generate the light obscuring matter may be contained or comprised within the canister.

The housing of the emission unit may optionally be formed from a polymeric or other heat insulating material. The housing may be a container for containing the canister. The housing may be or comprise a layer of polymeric or other heat insulating material disposed on the outer surface of the canister.

The canister and optionally the housing may each comprise a cylindrical side wall. The canister and optionally the housing may have a first end (e.g. a bottom end) and second end (e.g. a top end) opposite the first end. The first end of the canister and optionally the housing may comprise the outlet of the emission unit. The second end of the housing may comprise the one or more heat conduction arrangements. The heat conduction arrangements may be provided at the second end of the housing, and may extend at least partway or entirely through the housing.

The individual features and/or combinations of features defined above in accordance with any aspect of the present disclosure or below in relation to any specific embodiment of the disclosure may be utilised, either separately and individually, alone or in combination with any other defined feature, in any other aspect or embodiment of the disclosure.

Furthermore, the present disclosure is intended to cover apparatus configured to perform any feature described herein in relation to a method and/or a method of using or producing, using or manufacturing any apparatus feature described herein.

### BRIEF DESCRIPTION OF THE SEVERAL VIEWS OF THE DRAWINGS

Embodiments will now be described by way of example only, and with reference to the accompanying drawings, of which:

FIG. 1 is perspective cross sectional view of a visibility-impairing security device with the cross section taken through a plane through a longitudinal axis of the device;

FIG. 2 is a side cross sectional view of the visibility-impairing security device of FIG. 1 with the cross section taken through a plane through a longitudinal axis of the device;

FIG. 3 is top cross sectional view of the visibility-impairing security device of FIG. 1, with the cross section taken through a lateral plane through the device;

FIG. 4 is a perspective cross sectional view of the visibility-impairing security device of FIG. 1, with the cross section taken through a lateral plane through the device;

FIG. 5 is a perspective view of the visibility-impairing security device of FIG. 1, with part of a mounting member being cut away;

FIGS. 6 to 9 are perspective cut away views showing the insertion of an emission unit into a body of the visibility-impairing security device of FIG. 1;

FIG. 10 is a top perspective view of an upper part of the emission unit shown in FIGS. 6 to 9;

FIG. 11 is a side view showing the attachment or removal of a mounting member to the main body portion of the visibility-impairing security device of FIG. 1;

FIG. 12 is a detail view of an upper part of the main body portion of the visibility-impairing security device of FIG. 1;

FIG. 13 is a side view showing the mounting member attached to the main body portion of the visibility-impairing security device of FIG. 1;

FIG. 14 is a detail side view showing the attachment of a bottom cap to the main body portion of the visibility-impairing security device of FIG. 1;

FIG. 15 is a detail perspective view showing the bottom cap attached to the main body portion of the visibility-impairing security device of FIG. 1;

FIG. 16 is a rear perspective view of the visibility-impairing security device of FIG. 1, once assembled; and

FIG. 17 is a flowchart of a method for assembling the visibility-impairing security device of FIG. 1.

### DETAILED DESCRIPTION OF THE DRAWINGS

As used herein, except where the context requires otherwise, the terms “comprises”, “includes”, “has”, and grammatical variants of these terms, are not intended to be exhaustive. They are intended to allow for the possibility of further additives, components, integers or steps.

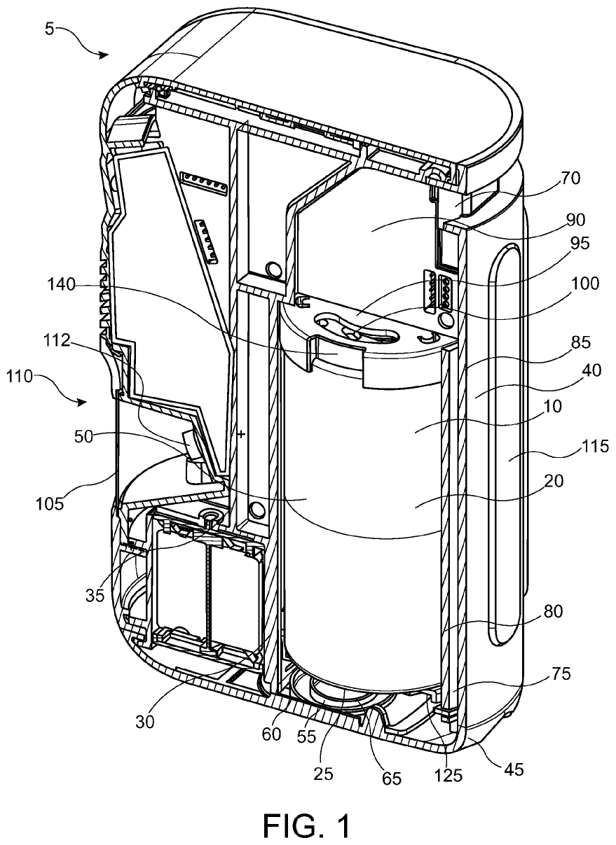

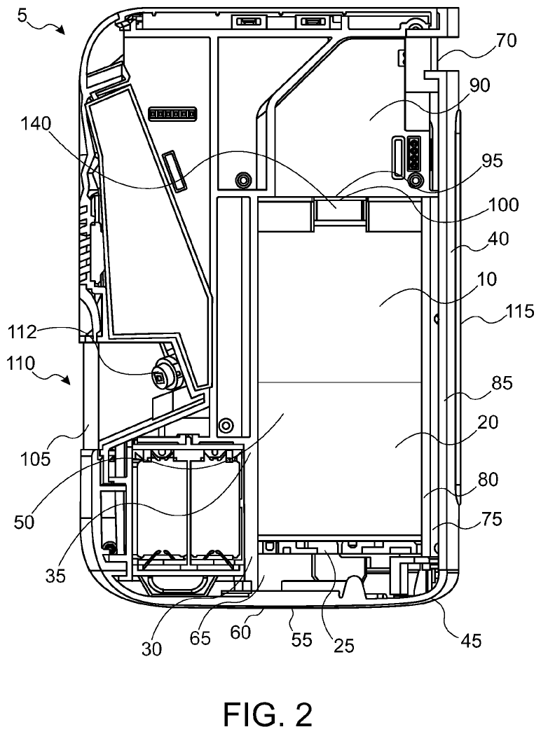

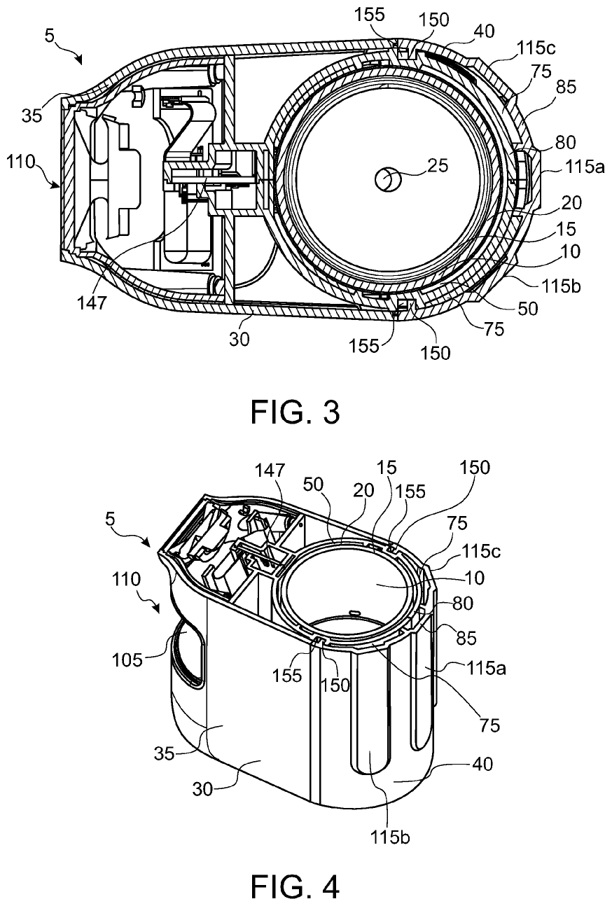

FIGS. 1 and 2 show a visibility-impairing security device 5 in top-side perspective and side cross sectional views respectively. The device 5 is configured to produce a gathering of air-suspended light-obscuring matter to obscure vision. In this particular example, the device 5 is configured to detect the motion or presence of a living entity within a detection area and, if the presence or motion of the living entity is detected, to emit the gathering of air-suspended light-obscuring matter, either automatically or upon receiving an emit instruction from a remote device that had been notified of the detected motion. In the example of FIGS. 1 and 2, some of the electronics for detecting the presence or motion of the living entity are omitted from the illustration, but can be seen in FIG. 3 or 4. However, different triggers could be used to trigger the release of the light-obscuring matter.

The device 5 comprises an emission unit 10 for emitting the light-obscuring matter. In this particular example, the emission unit 10 generates light-obscuring matter in the form of smoke upon delivery of energy (generally electrical energy). The emission unit 10 comprises a canister 15 in which the smoke is generated and a housing 20 around most of the canister 15. The canister 15 is provided with an outlet 25 (see FIG. 2) at one end for emitting the light-obscuring matter. The canister 15 contains chemicals that react responsive to the supply of the energy to generate the light-obscuring matter, which is then emitted from the outlet 25. The reaction to generate the light-obscuring matter is generally exothermic. Although a specific example of an emission unit 10 is described above, other types of emission units for emitting light-obscuring matter could be used, e.g. a pressurized canister filled with the light-obscuring matter could be used instead. Furthermore, although in examples the light-obscuring matter is generated in-situ when needed for use by the emission unit 10, it will be appreciated that stored light-emitting matter could be released instead. In addition, although a removable and replaceable emission unit 10 is described, the emission unit could be integral in the device (either as a single use device or where the chemical used to generate the light-obscuring matter or the light-obscuring matter itself is replaced, rather than the whole emission unit). As such, whilst the specific emission unit 10 described above has particular benefits, the emission unit is not limited to that specific construction.

The device 5 further comprises a body 30 for holding the emission unit 10. The body 30 in turn comprises a main body portion 35 and a mounting member 40. The body 30 also comprises a bottom cap 45 for closing the main body portion 35 and a mounting member 40. The main body portion 35 defines a chamber 50, in this case a generally cylindrical chamber 50, for receiving the emission unit 10 therein. The chamber 50 is shaped so as to hold the emission unit 10 at a defined location and orientation.

The chamber 50 is such that the emission unit 10 sits in the chamber 50 so that the outlet 25 of the emission unit 10 faces the bottom cap 45. Specifically, the bottom cap 45 comprises a first opening 55 and an openable cover 60 that is generally closed in use to close the first opening 55 but is selectively openable to permit release of the light-obscuring matter through the first opening 55. In examples, the openable cover 60 is in the form of a hinged door or flap. In examples, the pressure or force of the light-obscuring matter emitted from the emission unit 10 forces open the cover 60 to allow the light obscuring matter to be emitted out from the device 5 into a region external to the device 5. The cover 60 can be held in the default closed configuration by any suitable mechanism, such as by friction fit, a biasing member or spring, or the like, until it is opened, e.g. by the release of light-obscuring matter. However, other cover arrangements could be used.

In examples, a first hollow cavity 65 extends between the outlet 25 and the first opening 55/cover 60. In the example shown, the first cavity 65 is defined at least in part by the main body portion 35 and the bottom cap 45.

The openable cover 60 can provide many benefits, such as making it harder to block or otherwise tamper with the emission unit 10, minimising dust, water or foreign material that could otherwise enter the device 5 to potentially interfere with electronics or other components of the device, to provide a better visual appearance, amongst others. However, it can be detrimental if the openable cover 60 is prevented from opening, regardless of whether that is via a deliberate or accidental action or by a fault in the device. In order to counter this possibility, the device 5 is provided with at least one second opening 70 that is fluidly connected to the first cavity 65 via a fluid communication path 75.

The at least one second opening 70 is located in an upper region of the body 30. The first opening 55 is located at a lower region (e.g. in a lower half and preferably on a bottom surface when the device is mounted to a vertical wall) of the device whereas the at least one second opening 70 is located at an upper region (e.g. in an upper half and preferably on an upper or uppermost portion of an external rear wall) of the device 5. The at least one second opening 70 is optionally configured such that it is always open, i.e. it is not provided with a cover, door or flap.

The device 5 is configured such that emission of the light-obscuring matter is preferentially via the first opening 55. In other words, the at least one second opening may be only a backup exit path for the matter, in an event that the first opening is obstructed or blocked. For example, the device may be configured so that light-obscuring matter from the second opening is negligible, e.g. not observable by a human eye, or non-existent when the first opening is open (a door cover is in its open position) and the matter is passing through it. This may be achieved, for example, simply by having the outlet 25 of the emission unit 10 directly facing the first opening 55. This may be additionally or alternatively achieved by making the fluid communication path 75 between the first cavity 65 and the at least one second opening 70 convoluted or tortuous or by having a smaller total cross sectional area of the fluid communication path 75 or the at least one second opening 70 relative to the cross sectional area of the first opening 55. The above provide simple and reliable mechanisms for preferential emission from the first opening 55 over the at least one second opening 70. However, it will be appreciated that other mechanisms could be used, such as the provision of a constriction, valve, throttle or the like.

The main body portion 35 defines an interior rear wall 80. In this example, the interior rear wall 80 defines a rear part of the chamber 50 of the main body portion 35 in which the emission unit 10 is held. However, in other examples, the interior rear wall may not define part of the chamber 50. The mounting member 40 defines an exterior rear wall 85 of the body 30 (and of the device 5). The mounting member is arranged such that, when the mounting member 40 is fixed to the main body portion 35, the exterior rear wall 85 is spaced apart from the interior rear wall 80 to accommodate the fluid communication path 75 extending therebetween. This arrangement with both rear walls, i.e. the interior rear wall 80 and the exterior rear wall 85 with part of the fluid communication path 75 disposed therebetween, provides additional structural stability to the body 30.

The interior rear wall 80 and the exterior rear wall 85 extend over at least most of the height of the device 5. The at least one second opening 70 in this example is beneficially located though an upper or uppermost portion of the exterior rear wall.

The fluid communication path 75 extends generally rearwardly from the first cavity 65, between the bottom cap 45 and a lower part of the main body portion 35 before extending up through the body 30 between the interior rear wall 80 and the exterior rear wall 85. The body 30 comprises at least one second cavity 90. At least part of the at least one second cavity 90 is provided above, and extending directly overhead of at least part of, the chamber 50 that houses the emission unit 10, and thereby the emission unit 10 when installed. The at least one second cavity 90 is adjacent to and in fluid communication with the second opening 70. The fluid communication path 75 connects the first cavity 65 to the second cavity 90, and thereby connects the outlet 25 of the emission unit 10 with the second opening 70.

When operating correctly, the release of the light-obscuring matter by the emission unit 10 results in the opening of the cover 60 to open the first opening 55 and most or almost all of the light obscuring matter being released out from the device 5 via the first opening 55. However, when the first opening 55 is fully or partially closed or otherwise obscured, e.g. by the cover 60 not opening or only partially opening, a proportion, most or almost all of the light-obscuring material may instead be forced or otherwise conveyed from the first cavity 65 through the fluid communication path 75 up to the at least one second cavity 90 and then out from the device 5 via the at least one second opening 70. This may reduce or eliminate adverse effects on the device due to the first opening 55 being blocked and still result in the release of the light-obscuring matter.

The first opening 55 (optionally also the cover 60) and the outlet 25 of the emission unit may beneficially be oriented to direct the light-obscuring matter downwards and forwardly, but optionally more downwards than forwardly, from the device 5 when the light-obscuring matter is emitted through the first opening 55. This may provide a beneficial obscuring of vision in the area below and around the device 5, as the device is generally mounted at height. In the example, the first opening 55 is provided in a bottom surface of the device 5 (in the bottom cap 45) to facilitate this. However, this may make the first opening 55 and cover 60 more visible, accessible and easier to tamper with or accidentally block. By having the second opening 70 in the upper part of the device 5 and extending through the exterior rear wall 85 of the body 30 and device 5, the second opening may be less visible, and more difficult to tamper with or accidentally block. Furthermore, as the second opening 70 has a smaller cross sectional area than the first opening 55 and/or due to the second opening 70 being provided in an exterior rear wall 85 rather than a top or bottom end of the device 5, it may be less prone to dust or other foreign object ingress, which may allow for it to be left permanently open (i.e. without a cover). This may in turn provide a more robust secondary channel for emission of the light-obscuring material from the device 5. However, it will be appreciated that the second opening could be provided with a cover and many of the benefits could still be realized, at least to some extent.

Beneficially, the arrangement of the second cavity 90 and/or the at least one second opening 70 may provide dual functionality of both an additional expulsion route for the light-obscuring material and a heat venting arrangement for improving the venting of heat from the device 5, particularly of heat generated by the generation of the light-obscuring matter by the emission unit 10.

As noted above, at least part of the at least one second cavity 90 is located at least partially above and preferably directly overhead of the chamber 50 in which the emission unit 10 is held. One or more heat conduction arrangements 95 are provided between the second cavity 90 and the chamber 50/emission unit 10. The heat conduction arrangements 95 could comprise openings through which heat can pass or metallic or ceramic pathways or pathways filled with any other suitable material with a high heat conductivity.

As noted above, the emission unit 10 comprises the metallic canister 15 that is mostly covered by the housing 20 around the canister 15. The housing 20 is preferably formed from a heat insulating material having a heat conductivity much less than that of the canister 15. For example, the housing 20 may be formed from a polymeric material, such as a thermo-polymer. This may reduce unwanted thermal transfer into neighbouring components of the device 5 and may reduce the risk of burns due to handling a hot canister 15 whilst replacing the emission unit 10 after use. However, heat transfer portions 100 may be selectively provided in an upper part, e.g. the top surface, of the emission unit 10, wherein the heat transfer portions 100 extend from the canister 15 through the housing 20. That is, the heat transfer portions 100 are provided in or proximate an opposite end of the emission unit 10 to the end in which the outlet 25 is provided. The heat transfer portions 100 may be openings in the housing 20 or may be areas of metallic, ceramic or other material of high heat conductivity that extend through the housing 20. The heat transfer portions 100 may be adjacent or abut the one or more heat conduction arrangements 95 when the emission unit 10 is loaded into the body 30 of the device 5 in order to facilitate heat transfer from the canister 15 to the second cavity 90 and thereby out from the device 5 via the second openings 70. By having at least part of the second cavity 90 above the chamber 50 and the heat conduction arrangements 95 at the top of the chamber 50, rising heat is beneficially expelled more efficiently from the emission unit 10.

The rear of the device 5 may be the part of the device 5 comprising the mounting member 40 for mounting the device 5 to a surface, such as a wall, ceiling, post, or the like. The front of the device 5, which may be a side of the device opposite the rear of the device 5, may comprise a lens or sensing aperture 105 of a presence or motion sensor 110 or camera. That is, the rear or back of the device 5 may be a side of the device 5 opposite the lens or sensing aperture of the presence or motion sensor 100 or camera. The emission unit 10 is operable responsive to detection of motion or presence by the presence or motion sensor 110, which could be, for example, a PIR motion detector. In the illustrated example, the presence or motion sensor comprises the lens 105 (which could be a Fresnel lens), one or more pyroelectric sensors 112 that receives radiation from the lens 105 and electronics that process the signal form the pyroelectric sensor to determine when motion has occurred. In the illustrated example there are two pyroelectric sensors, but only one, which is directed out of the page, is visible in the drawing; the other is directed into the page to be symmetric about the plane of the page. The lens component 195 can provide the sensor (e.g. the pyroelectric sensor(s) 112 of the PIR motion detector or an image sensor if the lens is for a camera rather than a motion sensor) with a field of view that includes having a field of that is symmetric about a longitudinal axis of the passing through the top and bottom ends of the device 5, preferably in a perpendicular manner. The field of view may span more towards the bottom end of the body 30 than the top end of the body 30 so as be directed more towards a floor than a ceiling when installed in a room. In one example, a camera is located above the PIR motion senor, each having a field directed more towards a floor than a ceiling when installed in a room.

FIG. 3 shows a planar cross section view through the device 5 from above and FIG. 4 shows a perspective cross section view of the device form obliquely above and to the side and rear of the device 5. The sensing aperture 105 of the presence or motion sensor 110 is shown at the front of the device 5. The chamber 50 of the main body portion 35 has the emission unit 10 therein, with the outlet 25 of the emission unit facing downwardly (into the page) and forwardly. A rear wall of the chamber 50 forms the interior rear wall 80. The mounting member 40 that forms the exterior rear wall 85 is provided at the rear of the device 5 and connected to the main body portion 35. At least part of the exterior rear wall 85 is spaced apart from the interior rear wall 80 so that at least part of the fluid communication path 75 between the first cavity and the second cavity (and thereby between the outlet 25 of the emission unit 10 and the second outlet) extends therebetween.

The mounting member 40 comprises a plurality of mounting faces 115. The mounting faces comprise one of more mounting arrangements (not shown), such as thin wall portions defining areas for tapping a screw therethrough, adhesive pads, screw-holes, or the like. In this example there are three mounting faces 115a, 115b, 115c, but in other examples there could be more or less mounting faces. The mounting faces 115 are all flat planar surfaces. In this example, each mounting face 115 is elongate and extends in in the longitudinal direction of the device 5. The exterior rear wall 85 is generally curved about a longitudinal axis of the body 30 of the device 5 apart from at least the mounting faces 115. The mounting faces 115 include a central flat mounting face 115a between lateral flat mounting faces 115b, 115c. In this example, the lateral flat mounting faces 115b, 115c are respectively at +45 and −45 degree angles to the central flat mounting face 115a. In this example, the mounting faces 115 are configured to lie in a vertical plane when mounted, and may each have a longitudinal axis that is vertical. In other examples, the lateral mounting faces 115b, 115c are provided at different angles with respect to the central mounting face 115a and/or to each other, e.g. to provide the option of different mounting angles.

Beneficially, the mounting faces 115 stand proud of the surrounding parts of the exterior rear wall 85 and particularly of the second opening 70. That is, the mounting faces 115 may be located radially outwardly on the exterior rear wall 85 relative to at least the second opening 70 or other parts of the exterior rear wall 85. In this way, the second opening 70 is held off, and spaced apart from, the surface to which the device 5 is mounted via the mounting faces 115 in use.

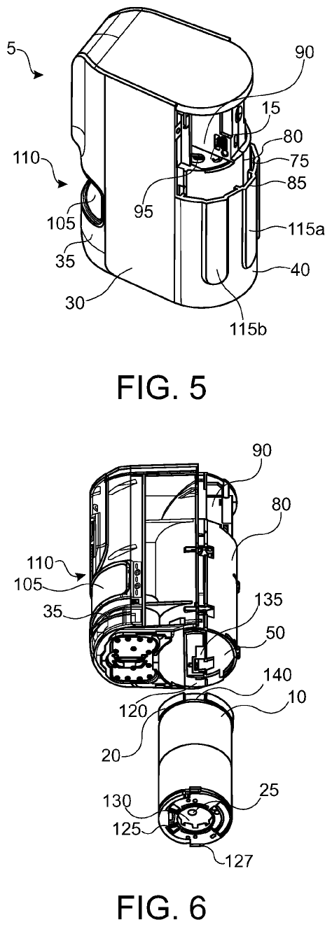

FIG. 5 shows a perspective view of the device 5 from above and to the rear and side. An uppermost section of the mounting member 40 has been cut away to show the at least one second cavity 90 more clearly. The fluid communication channel 75 can be seen extending between the exterior rear wall 85 and the interior rear wall 80. The top of the emission unit 10 and the heat transfer portions 100 therein can be seen through the heat conduction arrangements 95 (in the form of openings in the top of the chamber 50) in a bottom surface of the at least one second cavity 90.

In the example of FIGS. 1 to 5, the emission unit 10 is separate from the device 5 and can be installed, removed and interchanged, as required. FIG. 6 is a perspective view of the main body portion 35 from below and to the side, and which shows the insertion of the emission unit 10 into the chamber 50 in the main body portion 35. In FIG. 6, part of the main body portion 35 is depicted as translucent to assist in understanding of the internal structure. To insert the emission unit 10, the bottom cap 45 is removed. The chamber 50 is open at the bottom and generally cylindrically shaped to complement the outer shape of the emission unit 10. In this way, the emission unit 10 can be slid into the chamber 50 from the bottom.

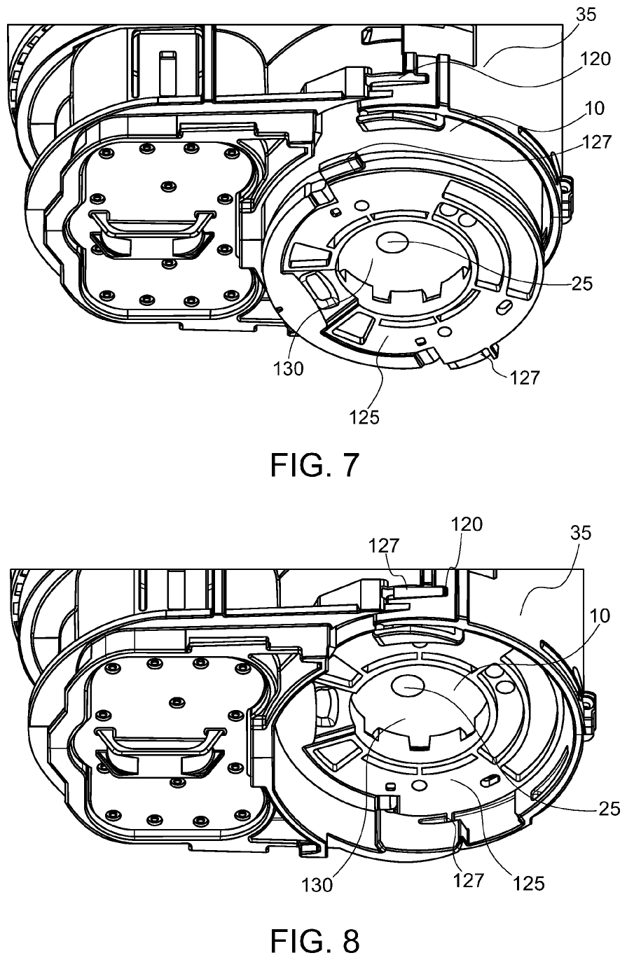

As shown in FIGS. 7 and 8, a lower part of walls of the chamber 50 are provided with twist fit members 120. A locking ring 125 can be inserted into the bottom end of the chamber 50. The locking ring 125 has flanges 127 that engage with the twist fit members 120 so that the locking ring 125 can be rotated to lock the locking ring 125 into the bottom of the chamber 50 to lock the emission unit 10 into the chamber 50. The lock ring 125 has an aperture 130 corresponding with the outlet 25 so that the light-obscuring matter can be ejected by the emission unit 10 out through the aperture 130 into and through the first cavity 65.

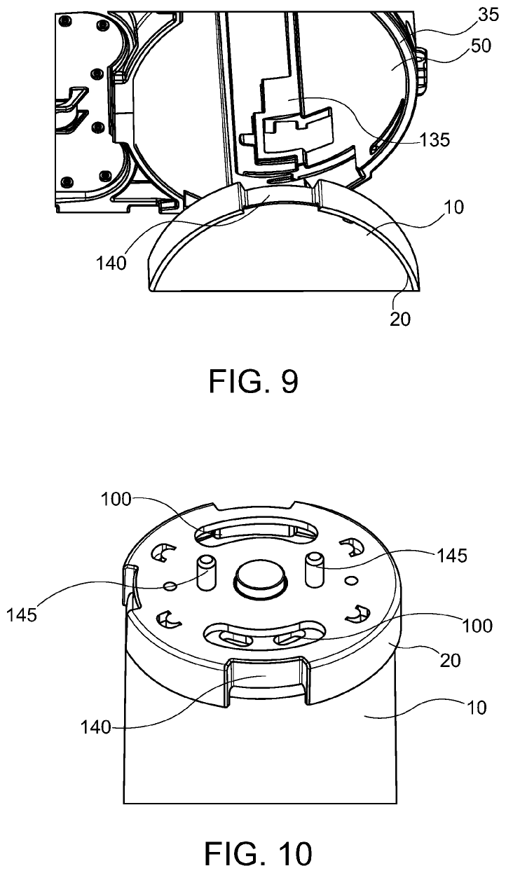

As shown in FIG. 9, the interior of chamber 50 is provided with longitudinally extending rails 135 that engage with corresponding notches 140 in the emission unit 10 to guide the emission unit 10 during the sliding of the emission unit 10 into the chamber 50 and to ensure a required rotational angle of the emission unit.

FIG. 10 shows a detail view of the top of the emission unit 10, showing the heat transfer portions 100 in the top surface of the emission unit 10 and the notches 140 that engage with the rails 135. Also shown are electrical contacts 145 of the emission unit 10 for connecting to control electronics 147 (see FIGS. 3 and 4). The control electronics 147 are provided between two parts of the second cavity 90 and implement logic to activate the emission unit 10. The control electronics 147 are connected to a battery or other power source of the device 5 in order to selectively supply the energy to activate the emission unit 10 to generate the light-obscuring matter, e.g. after the motion or presence sensor 110 detects motion or presence of a living entity (or according to other suitable activation conditions that would be apparent to one skilled in the art).

The main body portion 35 is selectively releasable from, and re-attachable to, the mounting member 40. In this way, the mounting member 40 can be fixed to the surface (e.g. the wall, ceiling, post or the like) and the main body portion can be selectively fixed to the mounting member 40 in use, but selectively released, e.g. to allow the body portion to be removed for easier changing of the emission unit 10, battery, etc.

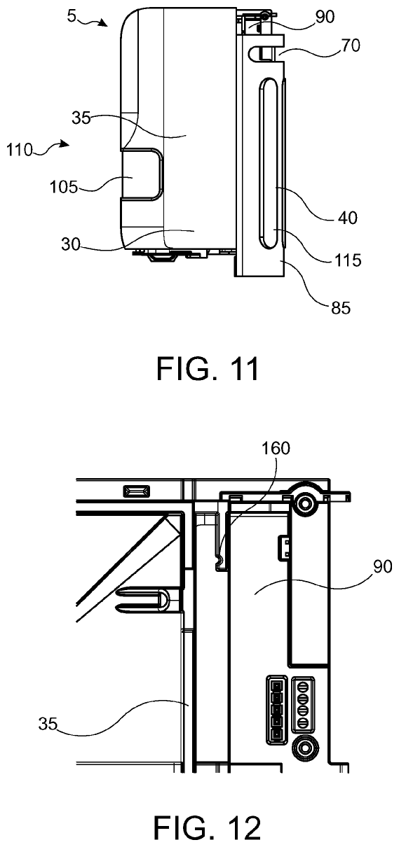

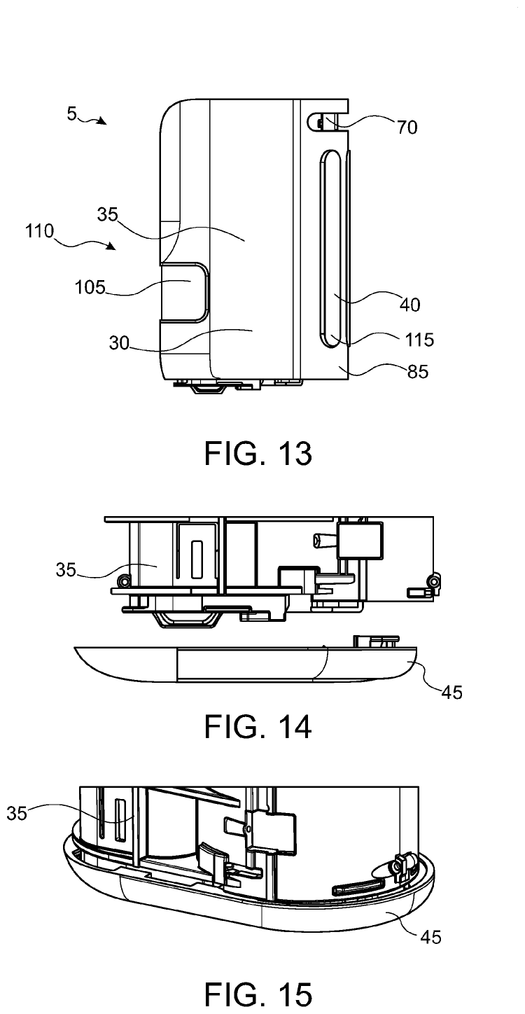

In this case, the main body portion 35 can be slid onto the mounting member 40 from above, as shown in FIG. 11. The mounting member 40 comprises rail guides 150 that run longitudinally on inner surfaces thereof (see also FIGS. 3, 4 and 5) that cooperate with corresponding grooves 155 in the outer surface of the inner rear wall to guide the relative sliding of the main body portion 35 and the mounting member 40. One of the main body portion 35 and the mounting member 40 is provided with at least one releasable engagement member 160 (e.g. a snap fit engagement member) for releasably engaging with a corresponding member on the other of the main body portion 35 and the mounting member 40 to reversibly lock the main body portion 35 and the mounting member 40. The releasable engagement members 160 can be located such that they engage when the main body portion has been fully slid onto the mounting member 40, as shown in FIG. 13.

Once the main body portion 35 has been fixed to the mounting member 40, then the bottom/lower part of the body 35 is closed with the bottom cap 45. As shown in FIGS. 14 and 15, the bottom cap is inserted into contact with the bottom of the main body portion 35 and then slid laterally to slide releasable locking members on the bottom cap 45 into engagement with corresponding releasable locking parts on the main body portion to lock the bottom cap 45 in place. The bottom cap 45 partially defines the first cavity 65 and part of the fluid communication path 75 between the first cavity 65 and the second cavity 90. The bottom cap 45 extends laterally outwardly beyond an outer side of the main body portion 35 so as to be flush with an outer side of the exterior rear wall 85. In this way the fluid communication path 75 can more readily extend round below the interior rear wall 80 and up through the body 30 between the interior rear wall 80 and the exterior rear wall 90.

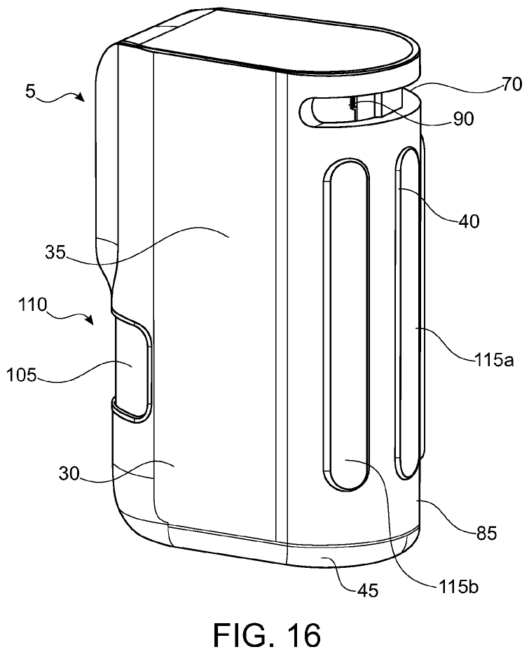

The finally assembled device 5 is shown in FIG. 16, which shows the at least one second opening at an upper portion of the body 30, specifically through an upper end of the exterior rear wall 85. The protruding flat mounting faces 115 are also shown.

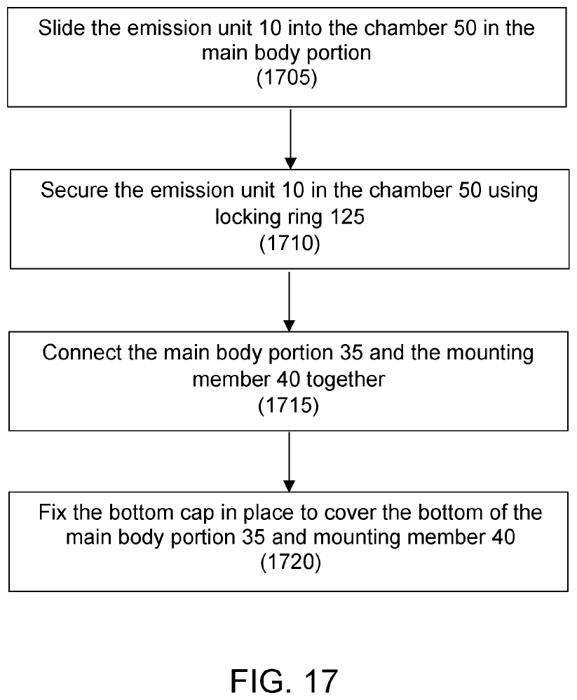

FIG. 17 is a flowchart detailing the assembly of the device 5.

In step 1705, the emission unit 10 is slid into the chamber 50 in the main body portion 35 along the rails 135 in the chamber 50.

In step 1710, the locking ring 125 is locked into the bottom end of the chamber 50 in order to secure the emission unit 10 in the chamber 50.

In step 1715, the main body portion 35 and the mounting member 40 are connected together by sliding the grooves 155 along the guide rails 150 until the releasable engagement members 160 engage to releasably lock the main body portion 35 to the mounting member 40.

In step 1720, the bottom cap is fixed in pace to cover the bottom of the main body portion 35 and mounting member 40.

Whilst the foregoing description has described exemplary embodiments, it will be understood by those skilled in the art that many variations of the embodiments can be made within the scope of the present invention as defined by the claims. Moreover, features of one or more embodiments may be mixed and matched with features of one or more other embodiments.

For example, although various sliding arrangements have been discussed, the manner of connecting parts together need not involve sliding. Although snap fit releasable locking mechanisms have been discussed, other releasable locking mechanisms could be used. Although a security device in which the emission unit 10 is activated to release the light-obscuring matter responsive to detection of the presence or movement of a living entity by the motion or presence sensor 110 is described, the release of the light obscuring matter may be responsive to different triggers, such as manually triggered or triggered by the output of other types of sensors, such as magnetic sensors, light beam sensors, and the like.

As such, the examples given in the detailed description are for illustrating the working of the invention and the scope is defined by the claims.

In addition, any priority document(s) of this application is/are hereby incorporated herein by reference in its/their entirety.

1. A visibility-impairing security device, for providing air-suspended light-obscuring matter, the device comprising:
a body for holding an emission unit, wherein the emission unit has an outlet for emitting the matter, the body comprising:
a first opening for the passing therethrough of the matter from the outlet; and
at least one second opening to enable the passage of the matter therethrough, at least in an event that that first opening is closed,
wherein the first opening is configured to emit the light-obscurinq matter downwardly or obliquely downwardly.

2. The device of claim 1, wherein the first opening is located proximal to a first end of the body and the second opening is located proximal a second end of the body that is opposite the first end.

3. The device of claim 1, wherein the first opening is located at a bottom end of the device and the second opening is located in a top half of the device.

4. The device of claim 1, wherein the second opening is configured to emit the light-obscuring matter at least partially from a rear of the device.

5. The device of claim 1, wherein the body defines or otherwise comprises:
a first cavity between the outlet and the first opening;
at least one second cavity at and/or adjacent the second opening; and
a fluid communication path between the first cavity and the second cavity.

6. The device of claim 5, wherein the body defines or comprises:
an interior rear side wall; and
an exterior rear side wall; and wherein
at least part of the fluid communication path extends between the interior rear side wall and the exterior rear side wall.

7. The device according to claim 1, comprising a cover for selectively closing the first opening, wherein the cover is configured to be operable between a closed configuration in which the cover closes the first opening and an open configuration in which the first opening is mostly or fully uncovered.

8. The device according to claim 1, wherein the body comprises a main body portion and a mounting member, wherein the main body portion at least partially defines a chamber for holding the emission unit therein, and the mounting member is configured for mounting the body to a surface, and the mounting member is at least one of: connected, releasably connected or releasably connectable to the main body portion.

9. The device according to claim 8, wherein the main body portion comprises at least one heat conduction arrangement that extends through a wall of the chamber for holding the emission unit between the top of the chamber and the second cavity, wherein the at least one heat conduction arrangement comprises at least one of: an opening, a void, and/or a channel at least partially filled with a heat conducting material.

10. The device according to claim 8, wherein the mounting member defines an exterior rear wall of the body, and wherein the mounting member comprises at least one flat mounting face for mounting to the surface, wherein the at least one flat mounting surface protrudes outwardly or otherwise stands proud from the rest of an outer surface of the exterior rear wall.

11. The device according to claim 1, wherein the second opening is permanently open.

12. The device according to claim 1, wherein the at least one second cavity is comprised of a plurality of sub-cavities divided from each other and distributed laterally in the device, wherein the sub-cavities extend generally longitudinally in a long direction of the device.

13. The device according to claim 1, wherein the device is configured such that emission of the light-obscuring matter is preferentially via the first opening in comparison with the at least one second opening.

14. A kit of parts or assembly comprising:
a visibility-impairing device for providing air-suspended light-obscurinq matter; and
an emission unit,
wherein the visibility-impairing device comprises a body for holding the emission unit, the body comprising: a first opening for the passing therethrough of the matter from the outlet; and at least one second opening to enable the passage of the matter therethrough, at least in an event that that first opening is closed, the first opening configured to emit the light-obscurinq matter downwardly or obliquely downwardly, and
wherein the emission unit has an outlet for emitting light-obscuring matter, the emission unit being comprised or locatable in the body of the visibility-impairing device.

15. The kit of parts or assembly of claim 14, wherein:
the emission unit is configured to generate the light-obscuring matter upon delivery of energy, and contains chemicals that react to generate the light obscuring matter upon delivery of the energy.

16. The kit of parts or assembly of claim 15, wherein:
the emission unit comprises a canister in which the light-obscuring matter is generated, the canister being formed from a metallic or other heat conducting material; and
a thermally insulating housing that covers at least some of an outer surface of the canister.

17. The kit of parts or assembly of claim 16, wherein the housing is provided with one or more heat conduction arrangements that are left open or through which the metallic or other heat conducting material extends.

18. The kit of parts or assembly of claim 17, wherein the one or more heat conduction arrangements are located at or proximate an end of the housing of the emission unit that is opposite or furthest from an end on which the opening of the emission unit is located.

19. A method of assembling the kit of parts of claim 14, the method comprising inserting the emission module into the body of the visibility-impairing device.

20. (canceled)

21. The device according to claim 1, wherein the second opening is located in a top half of the device.
